(19) United States
(12) Patent Application Publication
(10) Pub. No.: US 2016/0285405 A1
(43) Pub. Date: Sep. 29, 2016

(54) CONNECTOR ASSEMBLY FOR SOLAR PANELS WITH ASYMMETRICAL ENGAGMENT

(71) Applicant: Pegasus Solar Inc., San Jose, CA (US)

(72) Inventors: Erich Kai Stephan, Newport Beach, CA (US); Glenn Harris, Sausalito, CA (US)

(21) Appl. No.: 14/671,704

(22) Filed: Mar. 27, 2015

(51) Int. Cl. H02S 20/20; F16M 13/02

(52) U.S. Cl. CPC H02S 20/20; F16M 13/025

(57) ABSTRACT

In one embodiment, a connector assembly for solar panels includes an asymmetrical engagement assembly that forms a corner of the connector assembly. The asymmetrical engagement assembly also includes at least a first pair of flanges and a second pair of flanges extending from the corner of the connector assembly, with at least a portion of one flange of the first pair of flanges disposed between the second pair of flanges, and at least a portion of one flange of the second pair of flanges disposed between the first pair of flanges.

### TECHNICAL FIELD

The present disclosure relates to solar panel installation, and more specifically to connection assemblies for solar panels.

### BACKGROUND

As solar energy becomes more economical to produce electricity for direct consumption, more solar energy systems are being installed on rooftops. Typically, components of the solar energy systems such as solar panels are installed using conventional mounting structures, including, for example, support beams, L-type brackets, and the like. For such conventional mounting structures, solar panels are secured to the support beams, which in turn, are secured to the L-type brackets. The L-type brackets are further secured to a mounting structure such as a rooftop or other installation surface. However, such conventional mounting structures typically require overly complex structures, with each requiring precise dimensions. Accordingly, these conventional mounting structures can result in excessive material and extensive installation time.

### SUMMARY

Solar panel connector assemblies described herein provide simplified designs to facilitate efficient solar panel installation for various installation surfaces. For example, certain embodiments discussed herein reduce the overall number of components typically used in conventional solar panel mounting structures by employing, for example, asymmetrical engagement assemblies that allow a single solar panel connector assembly to be used interchangeably when mounting respective solar panels. These features further facilitate rapid installation, adjustment, and securement of a solar panel to a respective mounting surface.

According to some embodiments, a connector assembly for solar panels includes an asymmetrical engagement assembly that forms a corner of the connector assembly. The asymmetrical engagement assembly includes at least a first pair of flanges and a second pair of flanges extending from the corner of the connector assembly, with at least a portion of one flange of the first pair of flanges disposed between the second pair of flanges, and at least a portion of one flange of the second pair of flanges disposed between the first pair of flanges. Further, at least one flange of the first pair of flanges or at least one flange of the second pair of flanges defines a channel that receives a portion of a solar panel. The channel can be defined, for example, as an interior of the at least one flange. In addition, in some embodiments, the first pair of flanges and second pair of flanges are substantially symmetrical in dimension.

In some embodiments, the first pair of flanges extends from the corner of the connector assembly in a substantially orthogonal direction relative to a direction the second pair of flanges extends from the corner of the connector assembly. In addition, the portion of the one flange disposed between the first pair of flanges defines a gap between the first pair of flanges to receive a flange from a second asymmetrical engagement assembly of a second connector assembly. Likewise, the portion of the one flange disposed between the second pair of flanges defines a gap between the second pair of flanges that receives a flange from a third asymmetrical engagement assembly of a third connector assembly. For example, each flange of the pair of flanges can include apertures concentric with respective axes, such that a fastener can be disposed there-through to secure the connector assemblies to each other.

In certain other embodiments, the first pair of flanges comprises an upper flange and a lower flange, and the second pair of flanges comprises an upper flange and a lower flange. In such embodiments, the upper flange of the first pair of flanges defines a top portion of the asymmetrical engagement assembly, and the lower flange of the second pair of flanges defines a bottom portion of the asymmetrical engagement assembly.

In other embodiments, the connector assembly is secured to a solar panel using, for example, a fastener disposed in one or more apertures defined in the connector assembly, one or more notches to secure the connector assembly to the solar panel, extension members coupled to the connector assembly that form a portion of a frame to secure the solar panel, and the like.

In another exemplary embodiment, a connector assembly for solar panels includes a shelf that supports a portion of a solar panel and defines a corner of the connector assembly, and an asymmetrical engagement assembly coupled to the shelf and proximate the corner of the connector assembly. The asymmetrical engagement assembly includes at least a first pair of flanges and a second pair of flanges extending from the corner of the connector assembly, with at least a portion of one flange of the first pair of flanges disposed between the second pair of flanges, and at least a portion of one flange of the second pair of flanges disposed between the first pair of flanges. In these embodiments, the shelf includes at least two portions extending from the corner of the connector assembly in a direction equal to or less than orthogonal relative to each other, but in contrast, the first pair of flanges extends from the corner of the connector assembly in a substantially orthogonal direction relative to a direction the second pair of flanges extends from the corner of the connector assembly. In addition, one flange of at least the first pair of flanges or the second pair of flanges defines a corner wall for the shelf to secure the solar panel to the shelf.

In other exemplary embodiments, an asymmetrical engagement assembly includes a first pair of flanges extending from a corner of the asymmetrical engagement assembly, and a second pair of flanges extending from the corner of the asymmetrical engagement assembly. In these other exemplary embodiments, at least a portion of one flange of the first pair of flanges is disposed between the second pair of flanges, and at least a portion of one flange of the second pair of flanges is disposed between the first pair of flanges. Further, the first pair of flanges extends from the corner of the connector assembly in a substantially orthogonal direction relative to a direction the second pair of flanges extends from the corner of the connector assembly.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is an isometric perspective view of a connector assembly for solar panels according to one exemplary embodiment of this disclosure, viewed from an exterior of the connector assembly;

FIG. 2 is an isometric perspective view of the connector assembly shown in FIG. 1, viewed from an interior of the connector assembly;

FIG. 3 is a side elevation view of the connector assembly shown in FIG. 1;

FIG. 4 is a side elevation view of the connector assembly shown in FIG. 1, viewed from an opposite site shown in FIG. 3;

FIG. 5 is a top plan view of the connector assembly shown in FIG. 1;

FIG. 6 is an isometric perspective view of two coupled connector assemblies shown in FIG. 1;

FIG. 7 is an isometric perspective view of four coupled connector assemblies shown in FIG. 1;

FIG. 8 is an isometric perspective view of a connector assembly for solar panels according to another exemplary embodiment of this disclosure, viewed from an exterior of the connector assembly;

FIG. 9 is an isometric perspective view of the connector assembly of FIG. 8, viewed from an interior of the connector assembly;

FIG. 10 is a side elevation view of the connector assembly of FIG. 8;

FIG. 11 is a side elevation view of the connector assembly of FIG. 8, viewed from an opposite site shown in FIG. 10; and

FIG. 12 is a top plan view of the connector assembly shown in FIG. 10.

An element or functionally similar element is indicated with the same reference number.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Unless otherwise apparent, or stated, directional references, such as “front”, “side”, “top” “bottom”, “right,” “left,” “upper,” “lower,” “outward,” “inward,” etc., are intended to be relative to an orientation shown in the drawings for a particular embodiment. Such directional references are used for purposes of discussion and understanding, not limitation, as is appreciated by those skilled in the art.

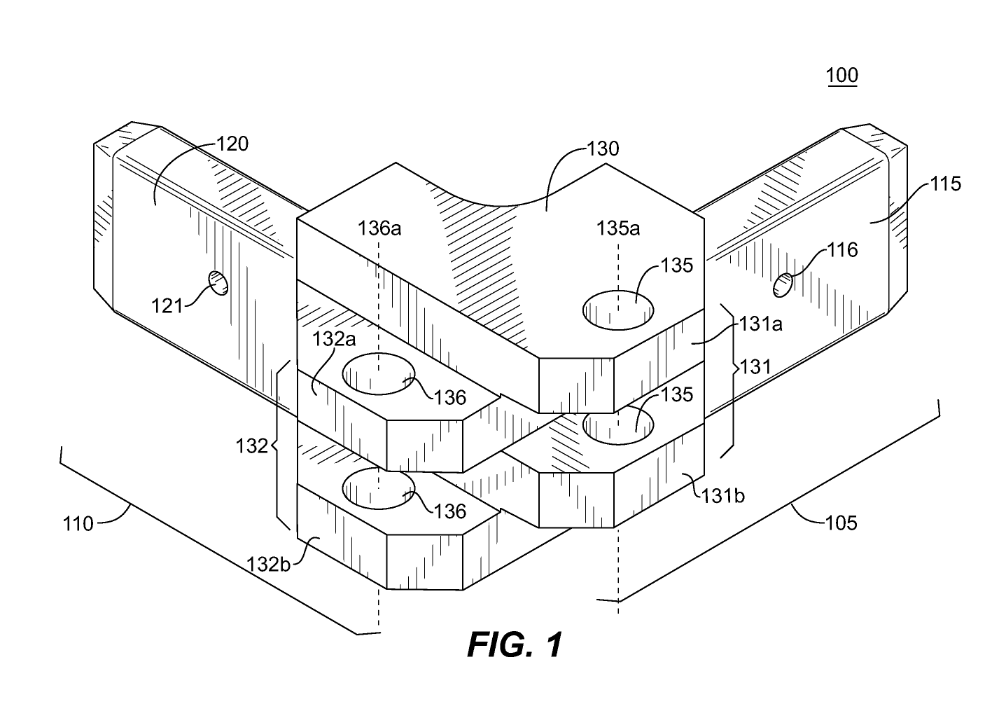

Referring now to the drawings, FIG. 1 is an isometric perspective view of a connector assembly 100 for solar panels according to one exemplary embodiment of this disclosure, viewed from an exterior of the connector assembly 100. As shown, connector assembly 100 includes a first side portion (generally referenced by reference number 105), a second side portion (generally referenced by reference number 110).

Each of first side portion 105 and second side portion 110 further include an extension member 115 and an extension member 120, respectively, and each extension member 115 and 120 may further include one or more apertures 116 and 121. Apertures 116 and 121 are configured or dimensioned to receive a corresponding fastener (e.g., a bolt, a screw, a nail, etc.) to secure connector assembly 100 to a solar panel (not shown) (e.g., a solar panel frame, housing, etc.). In some embodiments, extension member 115 and 120 form a portion of a frame along sides of the solar panel. However, in other embodiments, extension member 115 and 120 may be excluded from connector assembly 100. For example, certain installation applications support frameless installation (e.g., when the installation surface is a relatively flat/level surface). Accordingly to these installation applications, an adhesive glue or tape may secure the solar panel to corresponding connector assemblies—e.g., portions of the solar panel may rest within a channel defined by an interior of connector assembly 100 (discussed below), and/or portions of the solar panel may rest on top of connector assembly 100.

Connector assembly 100 also includes an asymmetrical engagement assembly 130 that forms a corner of the connector assembly 100. Asymmetrical engagement assembly 130 includes a pair of flanges 131 and a pair of flanges 132 that each extend from the corner of connector assembly 100—here, pair of flanges 131 extends proximate first side portion 105, and pair of flanges 132 extend proximate second side portion 110. Further, pair of flanges 131 include an upper flange 131a and a lower flange 131b, and pair of flanges 132 include an upper flange 132a and a lower flange 132b.

Moreover, pair of flanges 131 and pair of flanges 132 are substantially similar (or even identical) in dimension and are arranged in an asymmetrical configuration—e.g., having an offset for one of the pair of flanges relative to a top (or bottom) of asymmetrical engagement assembly 130, relative to each other and in relation to respective side portions 105 and 110, and the like. For example, as shown, the asymmetrical configuration includes at least a portion of one flange—here, upper flange 132a (of the pair of flanges 132) disposed between the pair of flanges 131, and at least a portion of one flange—here, lower flange 131b (of the pair of flanges 131) disposed between the pair of flanges 132. Further, as shown, upper flange 131a of pair of flanges 131 defines or forms a top portion of asymmetrical engagement assembly 130, and lower flange 132b of pair of flanges 132 defines or forms a bottom portion of asymmetrical engagement assembly 130. The portion of aperture 136 which resides in flange 132b (and in some cases, 132a), may be threaded to receive a threaded fastener, or may have a reduced diameter relative to the aperture 135 or 136 in flange 132a to engage a thread-cutting or thread-rolling fastener.

In this fashion, a single type of connector assembly—i.e., connector assembly 100 (including the asymmetrical engagement assembly)—can be used for a complete solar panel installation without requiring corner-specific connector assemblies (e.g., right corner, left corner, top corner, bottom corner, etc.) for each solar panel. Put differently, connector assembly 100 can couple or connect to other substantially similar (or identical) connector assemblies for one or more additional solar panels. For example, a fastener disposed through apertures 135 (which are concentric with aperture axis 135a), and a fastener disposed through apertures 136 (which are concentric with aperture axis 136a) can couple to one or more flanges for other asymmetrical connector assemblies, as discussed in greater detail below.

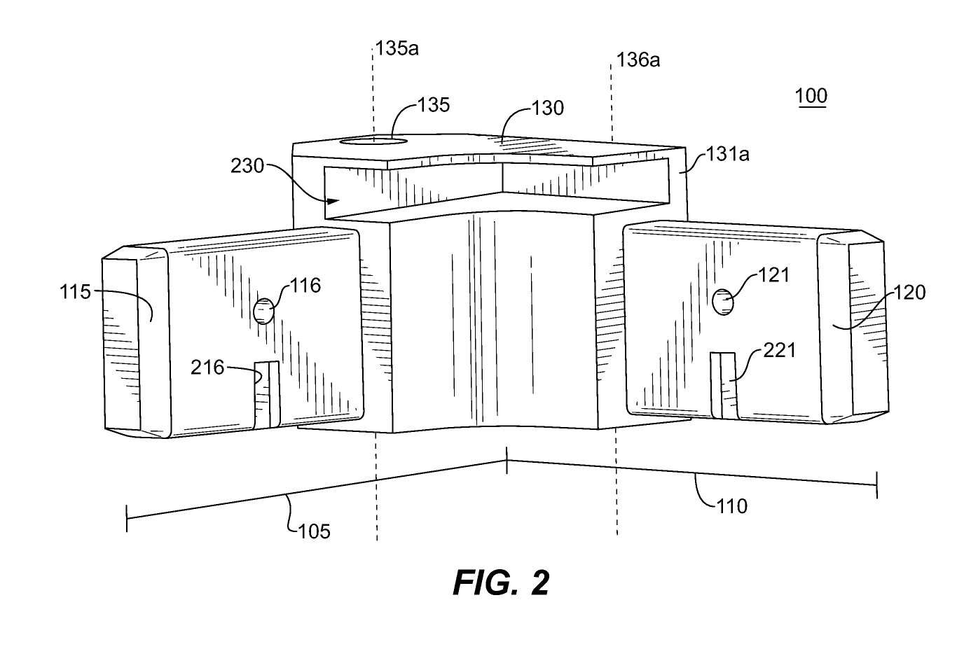

FIG. 2 is an isometric perspective view of the connector assembly of FIG. 1, viewed from an interior of connector assembly 100. As shown, one of the flanges—here, upper flange 131a of pair of flanges 131—defines a channel 230 that receives a portion of the solar panel—e.g., a corner portion of the solar panel.

In addition, each of extension member 115 and extension member 120 further define one or more notches 216 and 221, respectively. Notches 216 and 221, similar to apertures 116 and 121, facilitate coupling connector assembly 100 to the solar panel (e.g., a solar panel frame, housing, etc.), and/or coupling connector assembly 100 to extension members to form portions of a frame about the solar panel.

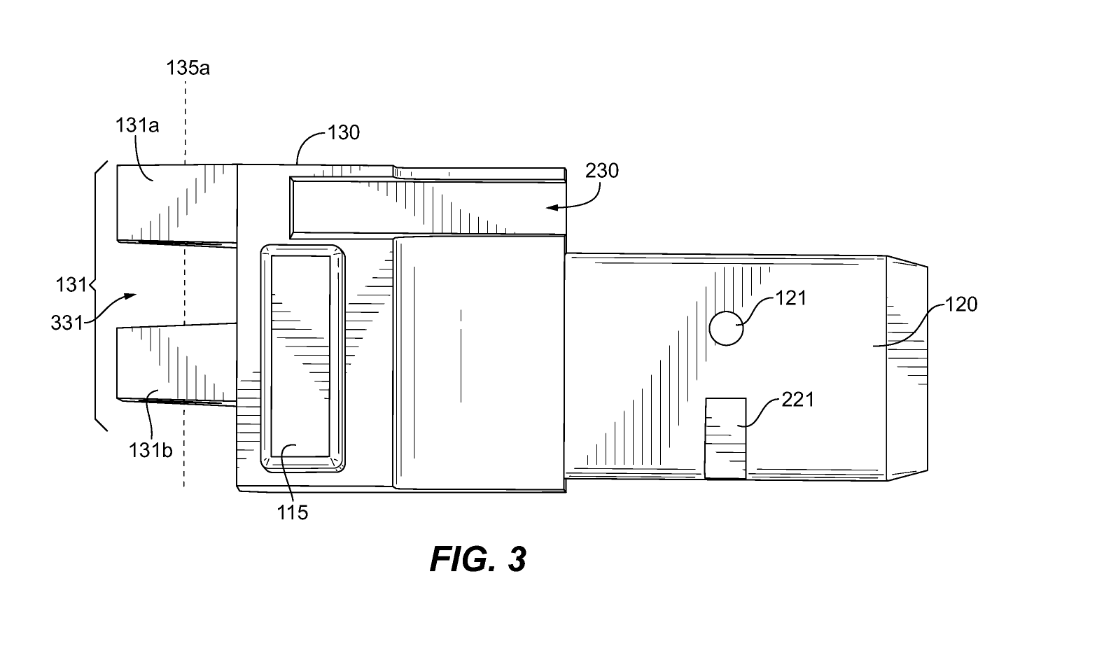

FIG. 3 is a side elevation view of the connector assembly 100. As discussed above, asymmetrical engagement assembly 130 includes two pairs of flanges (131, 132) arranged in an asymmetrical configuration, with at least a portion of one flange of each pair of flanges 131, 132 disposed between the other pair of flanges 132, 131, respectively. As shown in FIG. 3, the portion of upper flange 132a disposed between pair of flanges 131 further defines a gap 331 that receives a flange from a mating connector assembly (e.g., another connector assembly 100).

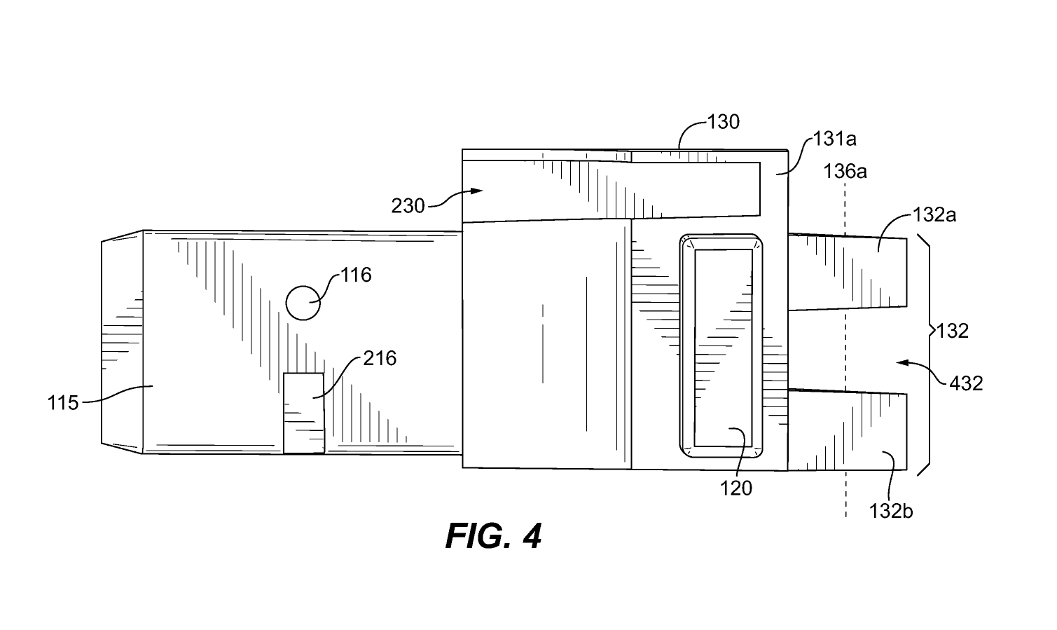

FIG. 4 is a side elevation view of the connector assembly 100 viewed from an opposite side shown in FIG. 3. FIG. 4, similar to FIG. 3, also shows the asymmetrical configuration for the pairs of flanges—here, pair of flanges 132. As shown in FIG. 4, the portion of lower flange 131b disposed between pair of flanges 132 further defines a gap 432 that receives a flange from a mating connector assembly (e.g., another connector assembly 100).

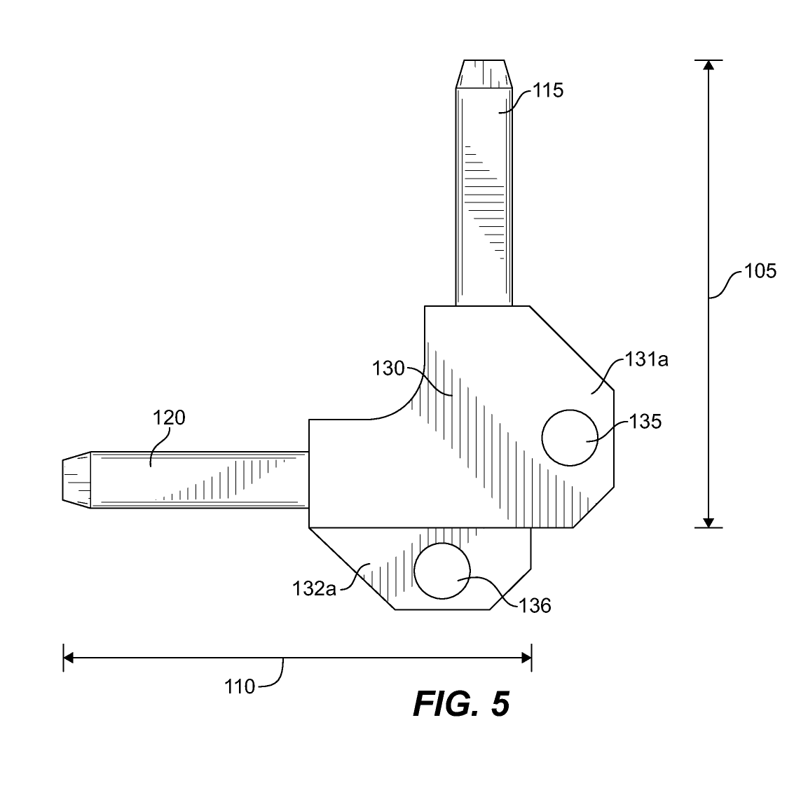

FIG. 5 is a top plan view of the connector assembly 100, particularly showing pair of flanges 131 (e.g., represented by upper flange 131a) extending from the corner of the connector assembly 100 in a substantially orthogonal direction relative to a direction that the pair of flanges 132 (e.g., represented by upper flange 132a) extends from the corner of the connector assembly 100.

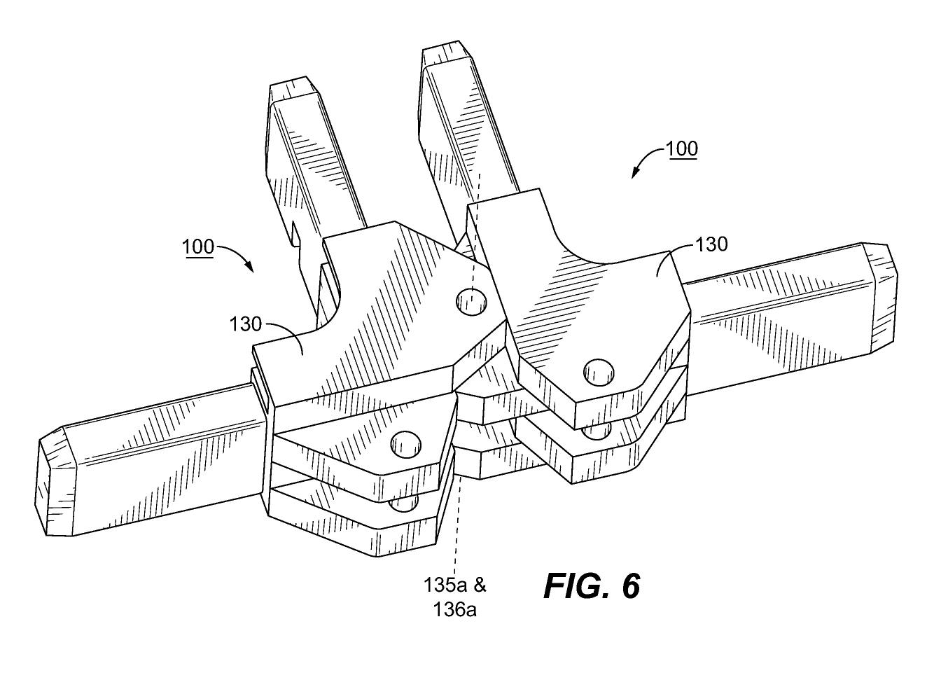

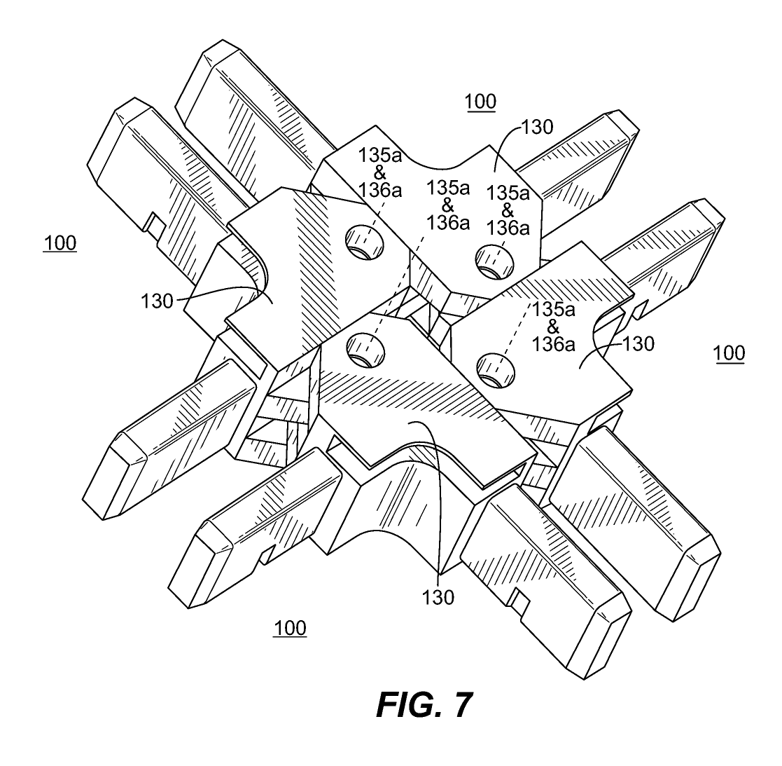

As discussed above, fasteners are disposed through apertures 135 and 136 to couple or secure the connector assembly 100 to another connector assembly, preferably a connector assembly including an asymmetrical engagement assembly configuration. For example, FIG. 6 is an isometric perspective view of two coupled connector assemblies 100. As shown in FIG. 6, the asymmetrical engagement assemblies 130 couple with each other (for respective connector assemblies) to align the aperture axes 135a and 136a for respective assemblies 100 (e.g., the aperture axes 135a and 136a become coincident). Similarly, FIG. 7 shows an isometric perspective view of four coupled connector assemblies 100.

FIG. 6 and FIG. 7, collectively, demonstrate connector assembly 100 employed for a solar panel installation. As discussed above, the asymmetrical engagement assembly portion for each respective connector allows a single type of connector to be used throughout a single solar panel array installation because the asymmetrical engagement assembly for each connector assembly mates with another asymmetrical engagement assembly without requiring specific placement or orientation of the connector assemblies relative to respective solar panels.

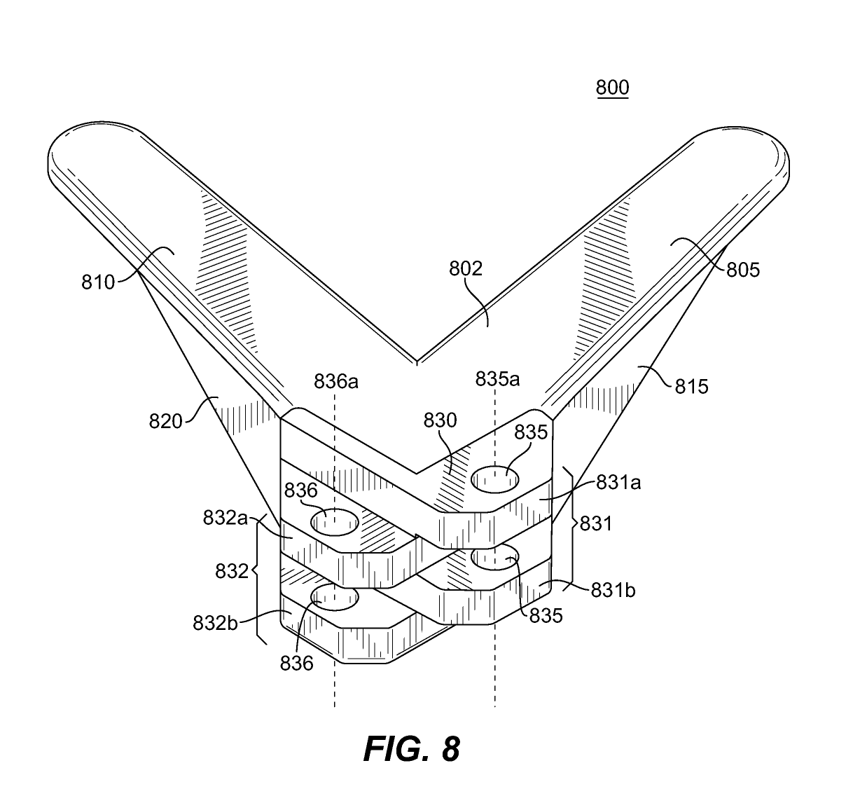

Referring now to FIG. 8, another exemplary embodiment for a connector assembly having an asymmetrical engagement assembly is illustrated. In particular, FIG. 8 is an isometric perspective view of a connector assembly 800, viewed from an exterior of the connector assembly.

As shown, connector assembly 800 includes shelf 802 that supports a portion of a solar panel (not shown) and defines a corner of the connector assembly 800. In particular, shelf 802 includes first side portion 805, a second side portion 810 extending from the corner of the connector assembly 800. Each of first side portion 805 and second side portion 810 further includes support struts 815 and 820, respectively, which provide additional support to shelf 802 when supporting a portion of the solar panel.

Connector assembly 800 also includes an asymmetrical engagement assembly 830 coupled to shelf 802 and proximate the corner of the connector assembly 800. Asymmetrical engagement assembly 830 includes a pair of flanges 831 and a pair of flanges 832 that each extend from the corner of connector assembly 100—here, pair of flanges 831 extends proximate first side portion 805, and pair of flanges 832 extend proximate second side portion 810. Further, pair of flanges 831 include an upper flange 831a and a lower flange 831b, and pair of flanges 832 include an upper flange 832a and a lower flange 832b.

In addition, pair of flanges 831 and pair of flanges 832 are substantially similar (or even identical) in dimension and are arranged in an asymmetrical configuration—e.g., having an offset for one of the pair of flanges relative to a top (or bottom) of asymmetrical engagement assembly 830. For example, as shown, the asymmetrical configuration includes at least a portion of one flange—here, upper flange 832a (of the pair of flanges 832) disposed between the pair of flanges 831, and at least a portion of one flange—here, lower flange 831b (of the pair of flanges 831) disposed between the pair of flanges 832. Further, as shown, upper flange 831a of pair of flanges 831 defines or forms a top portion of asymmetrical engagement assembly 830, and lower flange 832b of pair of flanges 832 defines or forms a bottom portion of asymmetrical engagement assembly 830. The portion of aperture 836 which resides in flange 832b (and in some cases, 832a), may be threaded to receive a threaded fastener, or may have a reduced diameter relative to the aperture 835 or 836 in flange 832a to receive a thread-cutting or thread-rolling fastener.

In this fashion, a single type of connector assembly 800 (similar to the embodiment shown in FIG. 1) can be used for a complete solar panel installation without requiring corner-specific connector assemblies (e.g., right corner, left corner, top corner, bottom corner, etc.) for each solar panel. That is, connector assembly 800 can couple or connect to other substantially similar (or identical) connector assemblies for one or more additional solar panels. For example, a fastener disposed through apertures 835 (which are concentric with aperture axis 835a), and a fastener disposed through apertures 836 (which are concentric with aperture axis 836a) can couple to one or more flanges for other asymmetrical connector assemblies, as discussed in greater detail below.

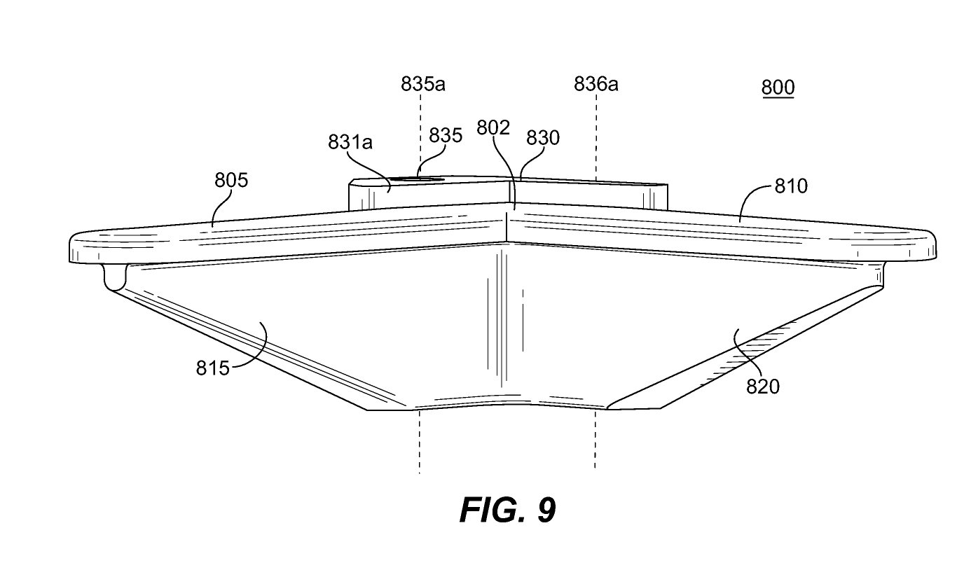

FIG. 9 is an isometric perspective view of the connector assembly of FIG. 8, viewed from an interior of connector assembly 800. As shown, one of the flanges—here, upper flange 831a of pair of flanges 831—defines a protrusion or a corner wall for shelf 802 to secure the solar panel to shelf 802.

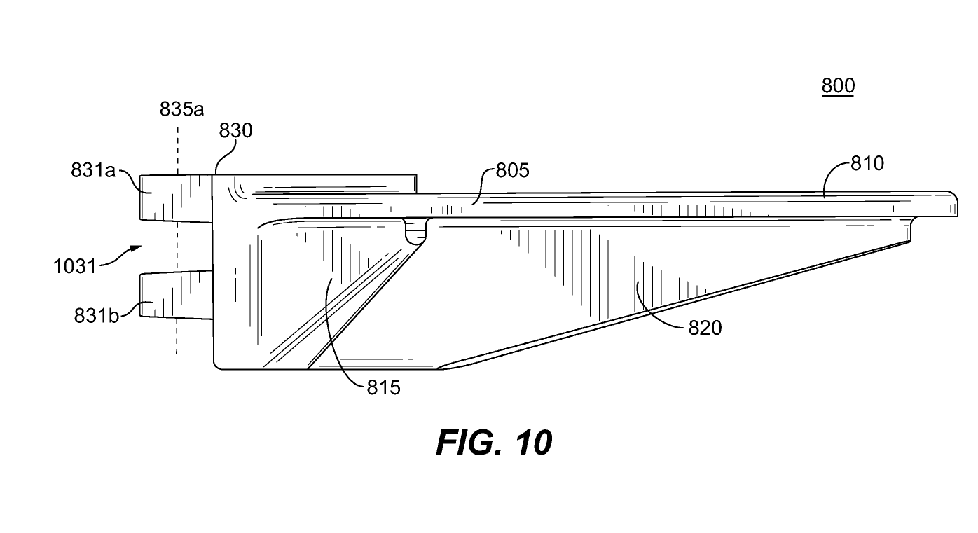

FIG. 10 is a side elevation view of the connector assembly 800. As discussed above, asymmetrical engagement assembly 830 includes two pairs of flanges (831, 832) arranged in an asymmetrical configuration, with at least a portion of one flange of each pair of flanges 831, 832 disposed between the other pair of flanges 832, 831, respectively. As shown in FIG. 10, the portion of upper flange 832a disposed between pair of flanges 831 further defines a gap 1031 that receives a flange from a mating connector assembly (e.g., another connector assembly 800 or even another connector assembly 100).

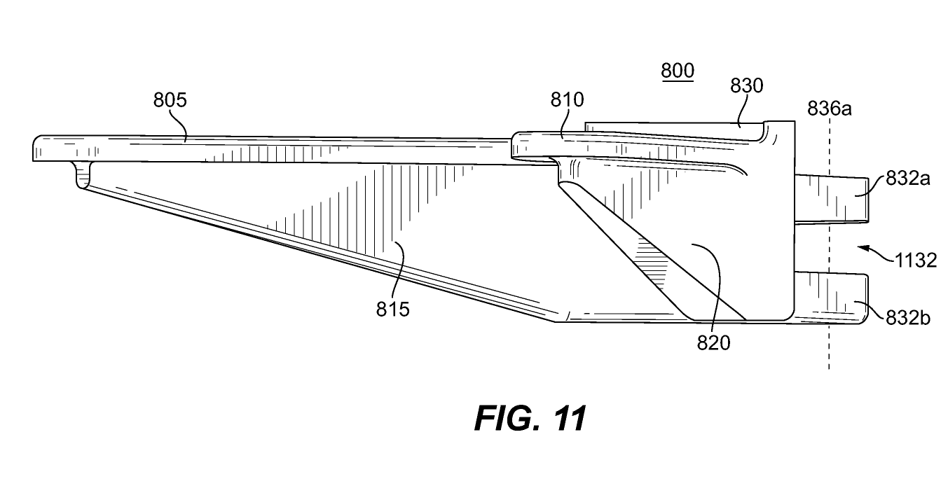

FIG. 11 is a side elevation view of the connector assembly 800 viewed from an opposite side shown in FIG. 10. FIG. 11, similar to FIG. 10, also shows the asymmetrical configuration for the pairs of flanges—here, pair of flanges 832. As shown in FIG. 11, the portion of lower flange 831b disposed between pair of flanges 832 further defines a gap 1132 that receives a flange from a mating connector assembly (e.g., another connector assembly 800 or even another connector assembly 100).

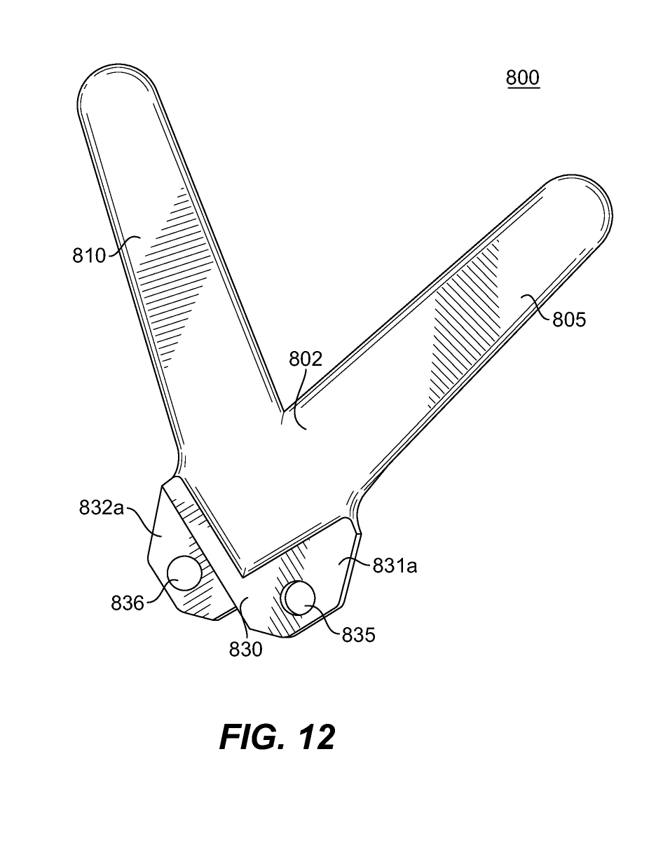

FIG. 12 is a top plan view of the connector assembly 800, particularly showing pair of flanges 831 (e.g., represented by upper flange 831a) extending from the corner of the connector assembly 800 in a substantially orthogonal direction relative to a direction that the pair of flanges 832 (e.g., represented by upper flange 832a) extends from the corner of the connector assembly 800. Further, as shown in FIG. 12, first side portion 805 and second side portion 810 of shelf 802 extend from the corner at less than a relative orthogonal direction. Put differently, while the pairs of flanges for asymmetrical engagement assembly 830 extend from the corner of the connector assembly 800 in an orthogonal direction, first side portion 805 and second side portion 810 of shelf 802 extend at less than an orthogonal direction.

As discussed above, FIGS. 8-12 collectively illustrate a connector assembly 800 having an asymmetrical engagement assembly 830, which can be used throughout an installation of solar panels. In particular, the asymmetrical engagement assembly for each connector assembly mates or couples with another asymmetrical engagement assembly of another connector assembly without requiring specific placement or orientation of the connector assemblies relative to respective solar panels.

Although a variety of examples and other features disclose certain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

1. A connector assembly for solar panels, comprising:
an asymmetrical engagement assembly that forms a corner of the connector assembly and includes at least a first pair of flanges and a second pair of flanges extending from the corner of the connector assembly, with at least a portion of one flange of the first pair of flanges disposed between the second pair of flanges, and at least a portion of one flange of the second pair of flanges disposed between the first pair of flanges.

2. The connector assembly of claim 1, wherein the at least the portion of the one flange disposed between the first pair of flanges defines a gap between the first pair of flanges to receive a flange from a second asymmetrical engagement assembly of a second connector assembly.

3. The connector assembly of claim 2, wherein the at least the portion of the one flange disposed between the second pair of flanges defines a gap between the second pair of flanges that receives a flange from a third asymmetrical engagement assembly of a third connector assembly.

4. The connector assembly of claim 1, further comprising:
a channel defined by at least one flange of the first pair of flanges or at least one flange of the second pair of flanges, the channel receives a portion of a solar panel.

5. The connector assembly of claim 4, wherein the channel is further defined along an interior of the at least one flange.

6. The connector assembly of claim 1, wherein the first pair of flanges extends from the corner of the connector assembly in a substantially orthogonal direction relative to a direction the second pair of flanges extends from the corner of the connector assembly.

7. The connector assembly of claim 1, wherein the first pair of flanges and second pair of flanges are substantially symmetrical in dimension.

8. The connector assembly of claim 1, wherein each flange of the first pair of flanges defines a flange aperture concentric with a first engagement axis, and each flange of the second pair of flanges defines a flange aperture concentric with a second engagement axis.

9. The connector assembly of claim 1,
wherein the first pair of flanges comprises an upper flange and a lower flange, and the second pair of flanges comprises an upper flange and a lower flange, and
wherein the upper flange of the first pair of flanges defines a top portion of the asymmetrical engagement assembly, and the lower flange of the second pair of flanges defines a bottom portion of the asymmetrical engagement assembly.

10. The connector assembly of claim 1, further comprising:
one or more side extension members coupled to the connector assembly that provide at least a portion of a frame to secure the solar panel.

11. The connector assembly of claim 1, wherein the asymmetrical engagement assembly further defines one or more apertures to secure the connector assembly to the solar panel.

12. The connector assembly of claim 1, wherein the asymmetrical engagement assembly further defines one or more notches to secure the connector assembly to the solar panel.

13. A connector assembly for solar panels, comprising:
a shelf that supports a portion of a solar panel and defines a corner of the connector assembly; and
an asymmetrical engagement assembly coupled to the shelf and proximate the corner of the connector assembly, the asymmetrical engagement assembly includes at least a first pair of flanges and a second pair of flanges extending from the corner of the connector assembly, with at least a portion of one flange of the first pair of flanges disposed between the second pair of flanges, and at least a portion of one flange of the second pair of flanges disposed between the first pair of flanges.

14. The connector assembly of claim 13, wherein the shelf comprises at least two portions extending from the corner of the connector assembly in a direction less than orthogonal relative to each other.

15. The connector assembly of claim 14, wherein the first pair of flanges extends from the corner of the connector assembly in a substantially orthogonal direction relative to a direction the second pair of flanges extends from the corner of the connector assembly.

16. The connector assembly of claim 13, wherein one flange of at least the first pair of flanges or the second pair of flanges defines a corner wall for the shelf to secure the solar panel to the shelf.

17. An asymmetrical engagement assembly, comprising:
a first pair of flanges extending from a corner of the asymmetrical engagement assembly; and
a second pair of flanges extending from the corner of the asymmetrical engagement assembly, with at least a portion of one flange of the first pair of flanges disposed between the second pair of flanges, and at least a portion of one flange of the second pair of flanges disposed between the first pair of flanges, and
wherein the first pair of flanges extends from the corner of the connector assembly in a substantially orthogonal direction relative to a direction the second pair of flanges extends from the corner of the connector assembly.
